(19) United States
(12) Patent Application Publication
(10) Pub. No.: US 2004/0010780 A1
(43) Pub. Date: Jan. 15, 2004

(54) Method and apparatus for approximate generation of source code cross-reference information

(75) Inventor: Michael J. Garvin, Nepean (CA)

Correspondence Address: OGILVY RENAULT, 1981 MCGILL COLLEGE AVENUE, SUITE 1600, MONTREAL, QC, H3A2Y3, CA

(73) Assignee: NORTEL NETWORKS LIMITED, St. Laurent (CA)

(21) Appl. No.: 10/192,596

(22) Filed: Jul. 11, 2002

(51) Int. Cl. G06F 9/45

(52) U.S. Cl. 717/143; 717/152

(57) ABSTRACT

A method and apparatus for quickly and efficiently generating approximate cross-reference information from source code uses a fuzzy parser in a first pass to process all source code files linearly to resolve cross-references where possible and provide a list of unresolved cross-references and other accumulated knowledge to a separate type resolver. Fast pattern matching is used for the parsing. In a second pass, the type resolver uses this accumulated knowledge which is essentially a class hierarchy, to resolve the type of identifiers using heuristics to make best guesses when required. Separating the fuzzy parser from the type resolver facilitates the process. The method trades absolute accuracy for robustness and speed. This permits the method to be used to parse very large bodies of software.

### CROSS-REFERENCE TO RELATED APPLICATIONS

This is the first application filed for the present invention.

### MICROFICHE APPENDIX

Not Applicable.

### TECHNICAL FIELD

The present invention relates generally to the parsing and compiling of source code for computer programs. More particularly, the present invention relates to an error tolerant parser that performs approximate parsing of source code.

### BACKGROUND OF THE INVENTION

Modern computer languages are of two general types: scripted and compiled. Scripted languages are interpreted directly from the script that a user inputs. Basic, Tcl/Tk and Lisp are examples of scripted languages. Compiled languages are first processed by a parser, and transformed (compiled) into a binary or machine specific format. Pascal, C/C++, and Ada are examples of compiled languages.

Parsers and interpreters do many of the same things but a parser is geared for parsing once, and producing a machine format that can be very efficiently used many times. Interpreters do just the opposite; they work well for parsing many times but produce an inefficient machine format.

Full parsers are usually used as part of a compiler and, consequently, they are very particular about the syntax of the code, because the code must compile properly to execute without error. Most parsers are therefore “brittle”, in that they fail to work when the source code is uncompilable or source files are missing. This makes them less useful for browsing and editing during software development. Full parsers usually provide a very high level of detail about the structure and elements of the source code. If the high level of detail is not required and errors or poor syntax in the source code are not of great concern, then a less rigorous parser can be used.

An approximate parser, commonly referred to as a “fuzzy” parser, performs basically the same functions as a full parser, but is not provided with a highly detailed knowledge of the source code. For example, it is programmed to determine that an identifier is being referenced, but not the type of identifier. Within certain limits, the higher the resolution of the fuzzy parser, the better. An advantage of a fuzzy parser is that the parsed code is not required to be “compilable”, and at least some of the source files can be missing or unlocatable.

Many commercially available tools for reverse engineering and software analysis use full parsers. Consequently, they are not adapted to be scaled to parse large bodies of source code, and fail to work when the source code is not compilable or some source files are missing. Fuzzy parsers are also commercially available. The commercially available fuzzy parsers may be able to parse uncompilable code, but they generally are not adapted to handle very large bodies of source code, that is, in excess of 3 million lines of code. However, many control systems (such as telecommunications, defense, aerospace and manufacturing control systems), require 10, 20 or even 30 million lines of code. Such large bodies of code are generally written by many developers, compounding the difficulty of managing and understanding the applications. Navigating paper listings to understand program structure, file interdependencies, and the like, is cumbersome and inefficient. As a result, sophisticated software engineering environments, including integrated development environments (IDE), source code analysis tools, and source code browsing tools, have been developed to aid developers in coping with the complexity.

Source code browsing tools present cross-reference information gleaned from a collection of files, in a hierarchy of views. In a first level, identifiers may be presented while, in a second or “global” level, the files where the identifiers are referenced and the way the identifier is referenced in those files is illustrated. In a third or “local” level, detailed information is presented to pinpoint the line and possibly the column where each reference to an identifier is made in a file. The partitioning of cross-reference information into global and local levels permits user queries to be performed at various levels of resolution, selecting more detailed views only when desired. This is important when browsing large scale systems because where there are thousands of files in which a given identifier is used, because presenting detailed information for all such files may overwhelm a user. Partitioning also facilitates query performance.

Walter Bischofberger, “Sniff—A Pragmatic Approach to a C++ Programming Environment”, (Usenix Association, C++ Technical Conference, 1992), discusses a C++ programming environment “Sniff” which provides browsing and cross-referencing tools. Sniff parses C++ code using a fuzzy recursive descent parser which has only a partial understanding of C++. It can deal with incomplete software systems containing errors, and extracts information about where and how the symbols of a software system are declared and where they are defined. A disadvantage of the recursive descent technique is that it is not the most efficient way of parsing very large bodies of code. Recursive descent often requires complicated backtracking and error recovery.

There therefore exists a need for a method of efficiently parsing very large bodies of code in a robust and efficient manner.

### SUMMARY OF THE INVENTION

An object of the present invention is to provide a method of parsing source code in a fast, robust and approximate manner.

Another object of the invention is to provide a fuzzy parser that can handle very large bodies of source code.

According to an aspect of the present invention, there is provided a method of parsing source code to extract cross-references and other source code browsing information comprising the steps of: in a first pass, performing an approximate parse of the source code, resolving resolvable cross-references and extracting browsing information and, in a second pass, applying heuristics to a stream of unresolved cross-references from the first pass to generate a more complete model of cross-references.

This method uses a fuzzy parser. Unlike a traditional parser, a fuzzy parser does not pull in dependant files (also known as “includes”), as it parses the source code. Instead, it pulls out as much information as it can in one pass of all source code. This first pass generates a list of unresolved cross-references to identifiers in the source code, and a database of information that the fuzzy parser was able to resolve or speculatively determine.

The fuzzy parser provides for fast and robust parsing, but lacks global knowledge about relationships between files. To address this, a type resolver is used. The type resolver can take the accumulated knowledge from a fuzzy parse of all the source files in a given system, and resolve the type of identifiers, which were previously ambiguous because their declaration was not seen at the same time as the identifier.

The fuzzy parser runs in a first pass through the source code, producing cross-references and several files that accumulate global knowledge about the source code. These intermediate files, along with a stream of unresolved cross-references (identifiers with no known type), are passed to the type resolver for a second pass.

The type resolver is a program that runs in a separate second pass through the unresolved cross-references and the generated database of information, and resolves as many unresolved cross-references as possible, given the database created in the first pass by the fuzzy parser. The database generated in the first pass is essentially a class hierarchy, and a flat list of aggregate structures along with all of their fields. These two sources of information permit the type resolver to “walk” across identifier expressions, resolving the type of an identifier as it goes.

The already complete cross-references from the first pass are then merged with whatever resolved cross-references the type resolver can complete. The final merged set of cross-references is close in quality to that of a normal compile, within about 80%-90% accuracy. The cross-references from the first pass include a special subset of references. These references are called the ‘unknowns’. These are references to any token that was not resolved, or queued for resolution by the type resolver. Every identifier will have mostly resolved references, but there may also be a few unknown references where that identifier could be referenced.

If the type resovler encounters identifiers that it can't resolve, then it stamps them as unknown references. This ensures that all tokens in the source code at least get an unknown reference. Without ‘unknown’ references, the fuzzy parser model is potentially incomplete.

When the user browses the references for an identifier, the unknowns are merged in on the fly, but have an indicator attached to them that shows the reference is only a ‘possible’ reference.

For example; the name of a C++ class might be used in three different source files, but in a fourth file there may be a reference to an identifier that has the same name of the class, but this identifier was never resolved properly, and was thereby captured as an unknown reference. When showing the user references to the class name, we must also show the fourth reference to the user since it might be a reference to the class. We also indicate to the user that it is only a possible reference.

The benefit of this approach is that it enables robust parsing. Some header files can be missing, and the source code does not need to be compilable. In addition, this method is faster than a normal compile because header files are not processed repeatedly, they are only processed once, just like a normal source file.

The ability to scale this technique to large bodies of source code is enhanced by encoding the information in ways that conserve space, parsing all source files only once and hierarchically arranging the cross-reference data so that it can be paged or narrowed in scope.

Advantageous uses of the present invention are efficient cross-referencing, browsing, searching and formatting source code, effective risk analysis of source code and performing compiler diagnostics.

Embodiments of the present invention are directed to parsers for modern computer languages such as C and C++, but not restricted thereto.

### BRIEF DESCRIPTION OF THE DRAWINGS

Further features and advantages of the present invention will become apparent from the following detailed description, taken in combination with the appended drawings, in which:

FIG. 1 is a flow diagram of the fuzzy parser process in accordance with an exemplary embodiment of the present invention;

FIG. 2 is a flow diagram illustrating the fuzzy parser run as a single process in accordance with an embodiment of the present invention;

FIG. 3 is a flow diagram illustrating the fuzzy parser process as multiple parallel processes in accordance with an embodiment of the present invention;

FIG. 4 is a flow diagram of the main parse loop of the fuzzy parser in accordance with an exemplary embodiment of the present invention; and

FIG. 5 is a schematic diagram of a fuzzy parser system in accordance with an exemplary embodiment of the present invention.

It will be noted that, throughout the appended drawings, like features are identified by like reference numerals.

### DETAILED DESCRIPTION OF THE PREFERRED EMBODIMENT

The invention provides a method and apparatus for parsing very large bodies of code in an efficient and robust manner. The parsing is performed in independent first and second passes. In the first pass, a fuzzy parser builds a multi-component software model of a parsed source file which is used in a second pass by a type resolver, which uses the components to convert or filter unresolved cross-references into resolved cross-references to a greatest possible extent. Since the parsing is separated from type resolution and each process is linear, parallel processing of a collection of source files is possible.

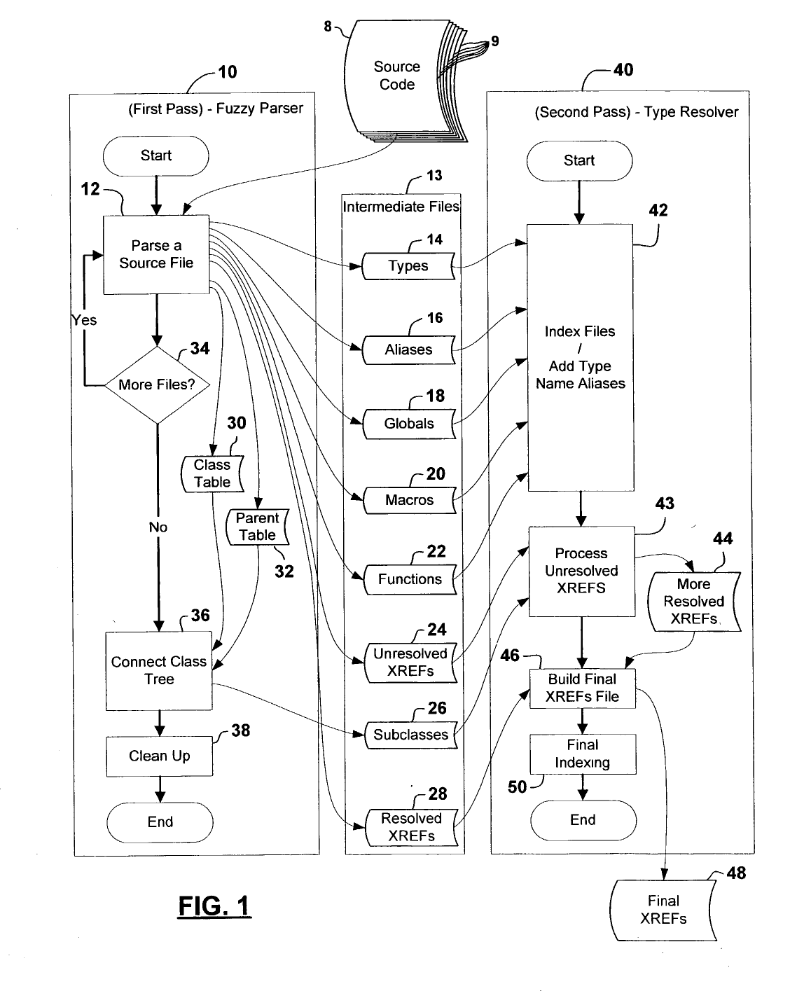

FIG. 1 is a general flow diagram of the fuzzy parser process in accordance with an embodiment of the invention. The parsing process takes source code 8 which can consist of multiple files 9 and produces a list of cross-references 48. As shown, the cross-reference generation process is divided into two passes. The first pass is performed by a fuzzy parser process 10, while the second pass is performed by a type resolver process 40.

When generating the cross-references for a given source code file 9, the fuzzy parser process 10 guarantees that all identifier tokens get at least an unknown reference (completeness) tag. The fuzzy parser process generates cross-reference information that is as detailed as possible. The unresolved cross-references 24 and the resolved cross-references 28 are preferably stored as hash tables.

As the fuzzy parser process 10 parses the source code files 9 (the parse phase), it creates several components of a software model:

A database of aggregate definitions (Types file 14);

A list of possible type alias names for the aggregates (Aliases file 16);

A list of all known global variables (Globals file 18);

A list of all known macros (Macros file 20);

A list of all known global functions (Functions file 22)

A list of all unresolved cross-references (Unresolved XREFs file 24);

A class hierarchy (Subclasses file 26); and

A partial list of resolved cross-references (Resolved XREFs file 28).

By producing this information in the first pass 10, the second phase “type resolution” 40 can proceed without any direct reference to the source code 8. The type resolver process uses the components listed above to convert or filter the unresolved cross-references 24 into properly resolved cross-references to an extent that is possible.

Both the fuzzy parser 10 and the type resolver 40 use heuristics to evaluate cross-references and other elements of the source code. In this document, “heuristics” are defined as “best guess strategies”. In general, this pragmatic approach is taken to trade off absolute accuracy for significant gains in speed.

The fuzzy parser 10 does not accumulate global knowledge, that is, knowledge of relationships between source files 9. Each file is processed independently. However, as the fuzzy parser 10 parses a system of source code 8, it records the locations of all class definitions. These definitions are then consolidated at the end of a parse to produce a flat Subclasses file 26 (in ASCII, for example). Each line in the flat Subclasses file 26 maps one class to its parent class. If a class has no parent class, the parent value is set to “NIL”. The flat Subclasses file 26 is later converted into a binary version (to facilitate queries) by the type resolver 40. A purpose of this file is to permit the type resolver 40 to start at a given class, and work upwards through an inheritance tree.

The class hierarchy is constructed in two steps. The first step is performed when a class declaration is found in the source code 8. At that point, a record is made of the class that was found, where it was found, and the names of the parent classes. Note that at this point the fuzzy parser 10 cannot know where the parent classes are defined, because the header files are not processed beforehand, as in a full parser.

In general, after parsing all files 9, the fuzzy parser 10 passes through the records of class declarations and associates the child classes with parent classes. For each parent class name cited in a class declaration, the fuzzy parser 10 adds one link from the child class to the parent class. If the parent class is defined in multiple files, then one link from the child class is added to each of the possible parent classes. When this is accomplished for each class that was found, the class tree or hierarchy is complete.

The fuzzy parser 10 parses each source file individually in step 12 and produces a file of resolved cross-references (Resolved XREFs 28) and several other intermediate files 13 described above (Types 14, Aliases 16, Globals 18, Macros 20, Functions 22, Unresolved XREFs 24) which are later used by the type resolver 40, as well as some internal tables (Class table 30, Parent table 32) which are processed to produce the Subclasses file 26 for use by the type resolver 40.

The Types file 14 is an index of all aggregate types (class, structure or union) indexed by uniquely generated names. The record for each unique name is a definition of the members (both data and methods) for the given aggregate. Because an aggregate name may be defined in multiple header files, or have several type names associated with it, there is a potential for type aliases. This is handled using an Aliases file 16 to provide a mapping between all uniquely generated aggregate names and their various alias names (the names actually appearing in the source code). Once the Aliases file 16 is processed by the type resolver 40, the Types file 14 is updated so that aggregates can be located using their respective alias names.

The Globals file 18 is a flat ASCII file containing a list of all known global definitions of variables. The Macros file 20 is a flat ASCII file containing a list of all known macro definitions. The Functions file 22 is a flat ASCII file containing a list of all known global function definitions. The Unresolved XREFs file 24 is a flat ASCII file that contains a stream of cross-references that the fuzzy parser 10 is not able to resolve. The XREFs file 24 is the primary input to the type resolver 40.

The fuzzy parser does not attempt to procure global knowledge, that is knowledge of relationships between source files. Each source file is processed independently. However, as the fuzzy parser 10 parses a system of source code, it records locations of all class definitions and collects the definitions in a Class table 30. The fuzzy parser 10 therefore relates the class names to the files in which they were defined. The fuzzy parser 10 tracks the parent of any given class in another table, the Parent table 32. The Parent table 32 stores parent/child pairs that are found during the first pass by the fuzzy parser 10.

After all the source files have been parsed by the fuzzy parser 10, the process flow continues through step 34 to step 36. The definitions in the Class table 30 and the Parent table 32 are then consolidated in step 36 “Connect Class Tree” to create a Subclasses file 26. The Subclasses file 26 is preferably stored as a flat ASCII file that maps each child class to its parent class, thereby providing a class hierarchy. The purpose of the Subclasses file 26 is to enable the type resolver 40 to work upwardly in the inheritance tree from any given class.

The cross-references that the fuzzy parser 10 can resolve in the first pass are stored in the Resolved XREFs file 28. This is also preferably stored as a flat ASCII file. The fuzzy parser 10 can usually resolve obvious cross-references such as method/function definitions local variable usage and globals defined within the current source file. More subtle cross-referencing, such as method or instance variable usage, is done in the second pass by the type resolver 40.

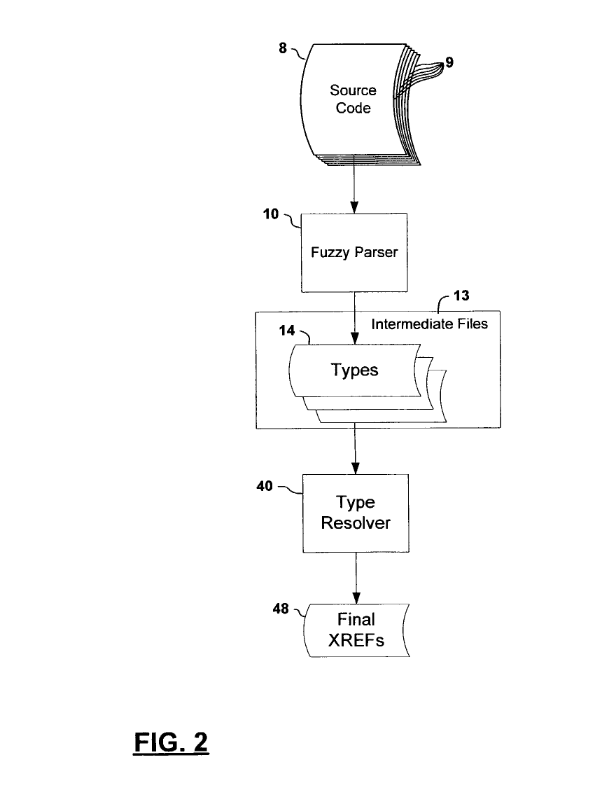

In one embodiment of the invention, the fuzzy parser 10 is run as a single process as shown in FIG. 2. In this case, the Types file 14 (one of the intermediate files 13) can be a binary indexed file to improve efficiency.

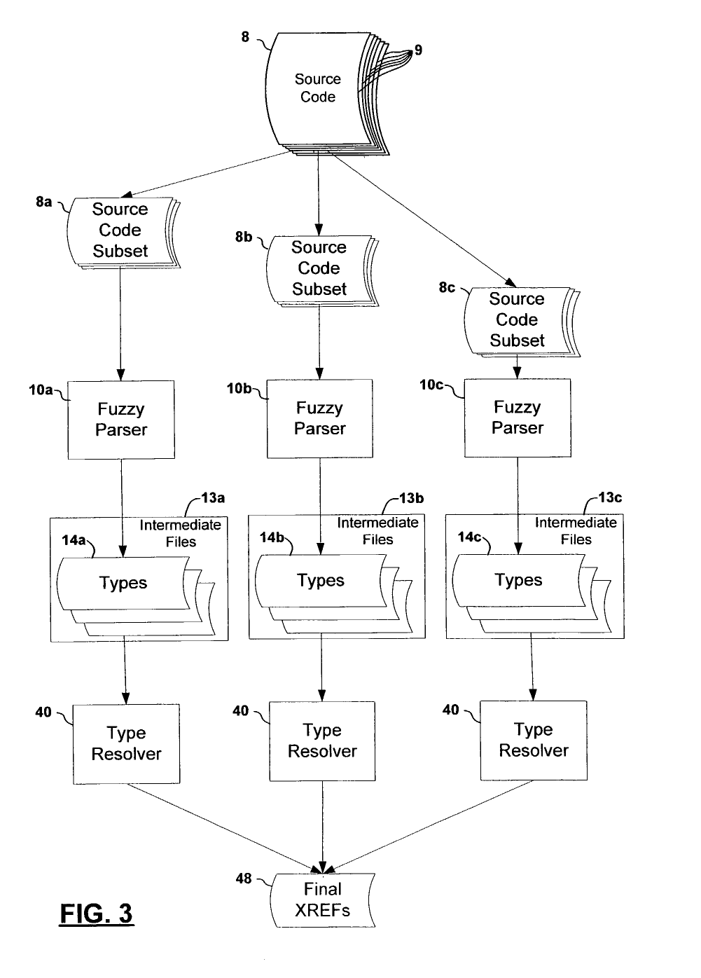

If the source code includes multiple files, multiple instances of the fuzzy parser 10 can be run in parallel on independent processors, as shown in FIG. 3. For example, a set 8 of source files 9 can be divided into sub-sets (8a, 8b, 8c) and each instance of the fuzzy parser 10a, 10b, 10c can parse a sub-set of source files 8. When all of the source files have been parsed, the output files (intermediate files 13a, 13b, 13c) from the respective instances of the parser (10a, 10b, 10c) are merged before they are presented to the type resolver 40. Preferably, the Types files 14a, 14b, 14c are saved as a flat ASCII file by each instance of the fuzzy parser 10 to facilitate merging. This parallel processing improves parsing speed, especially when the source code is stored in a large number of files, and it scales well to very large bodies of source code.

The type resolver 40 performs the second pass (FIG. 1) in several steps. In the first step 42, the type resolver 40 indexes the intermediate files created by the fuzzy parser 10 in the first pass. The first step 42 also adds all the type name aliases (for structures, classes and unions) to the Types file 14.

In step 43, the type resolver 40 uses the index files created in step 42 to process the Unresolved XREFs file 24. Processing consists of namespace look-up, identifying class members/data, or identifying global variable usage. The result is the More Resolved XREFs file 44 which is filled with cross-references resolved in step 43. The Resolved XREFs file 28 and the More Resolved XREFs file 44 are then merged in step 46 to produce the Final XREFs file 48 that contains all of the cross-referencing information available. Before the type resolver begins work on the unresolved references, the unresolved references are sorted, so that references within the same scope are grouped together. This vastly improves locality of references within the class hierarchy and permits greatly improved caching and faster resolution of a given unresolved reference. After the type resolver has indexed the intermediate files, it processes the unresolved references as one continuous stream of input. This step can be run in parallel by simply cutting the unresolved references stream into some number of equal pieces and running a separate instance of the type resolver on each piece. Each type resolver reads the same binary index(es). After the initial indexing of the intermediate file, ‘write’ access to the binary indexes is no longer permitted. The indexes are only created for speed, so once they are created, they can be opened for ‘read’ access by as many type resolvers as desired. Since each line of the unresolved references is independent of each other line, the unresolved references can be split into as many pieces as is needed for a desired parallelism.

The fuzzy parser 10 will now be described in more detail. As with any parser, the fuzzy parser 10 deconstructs a source file into logical tokens. These tokens are then processed using grammar or pattern matching. In the fuzzy parser, pattern matching is used. In many modern programming languages, such as C and C++, language elements can be identified by first breaking the input into chunks that end with a right brace ({) or semicolon (;) token. These chunks will not necessarily map directly to language structures or to lines of code. However, these chunks are very useful when pattern matching is applied in reverse. It has been demonstrated that one of the easiest ways to identify language elements is using reverse pattern matching. For example, working backwards from a right brace ({), a class declaration can be matched if an identifier associated with a ‘class’ keyword is located. This method enables rapid pattern matching, and is very efficient.

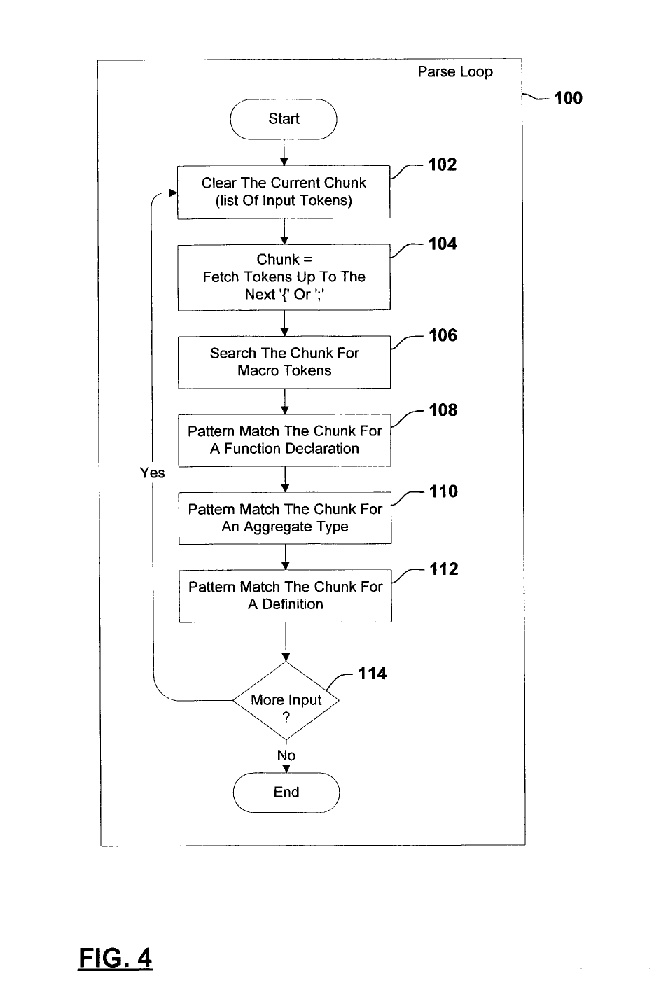

Referring now to FIG. 4, a central part of the fuzzy parser 10 is the parse loop 100, which processes the chunks of source code. For the purpose of improving parsing speed, an implicit assumption of the parse loop 100 is that all the tokens that are not of top level scope (i.e., inside a function, enumeration, or aggregate type), are dealt with by a sub-function of the parser. For example, when the top level signature of a function is found, the parser calls a separate function for parsing a body of the function/method. Similarly when an aggregate such as a C++ class is found, a sub-parser is invoked to parse an inner part of the aggregate to gather up all the definitions of instance variables and methods. The main parse loop 100 only searches for top level entities. If it fails to identify a top level entity, the inner tokens might be falsely identified as something they are not.

In step 102, an input buffer is cleared to prepare for a next chunk of source code to be read into the buffer. In step 104, the chunk of source code is read into the input buffer by fetching tokens until a right brace or semi-colon is encountered. In step 106 , the chunk is scanned for Macro tokens. Any macro tokens found are cross-referenced without delay.

In step 108, reverse pattern matching for function declarations is performed. Before the reverse pattern matching is performed, the chunk of source code in the input buffer is processed through two stages of initial processing: filtering and identifier reconstruction. First, spaces, pre-processor directives and comments are filtered out to speed up reverse pattern matching. If template specifications are found, then they are gathered up into a single token. This ensures that template functions are cross-referenced with their corresponding template specifications. If an ‘operator’ keyword is found, then the keyword and the following tokens up to but not including the right parenthesis ‘(’, opening token of the parameter list, are joined to form a single token. As described above with respect to templates, this ensures appropriate cross-referencing. A final filter step is done to ensure that any identifiers separated by a double colon (::) token are joined together. This ensures that identifier tokens are always complete, as they should be.

In step 110, reverse pattern matching is performed for aggregate types. The method scans backwards through the chunk of source code in the buffer for keywords ‘enum’, ‘class’, ‘struct’ and ‘union’. If the ‘enum’ keyword is found, all tokens are skipped until a next right brace token is located. Checks are then made to ensure that the next right brace token is preceded by an identifier (tag). The body of the enumeration is scanned (and ignored) and any tags after the body up to a next semi-colon token are scanned and cross-referenced. If the ‘class’, ‘struct’ or ‘union’ keyword is found, flags are set to note which keyword was found, a unique type name is generated for the aggregate, and an inner loop is launched to handle the aggregate. The inner loop searches for four beacons: a right brace token, an equal sign (=) token, a colon (:) token or an identifier token.

When a class/struct/union is found along with an identifier and a ‘{’ (left brace), then everything between that ‘{’ and its matching ‘}’ (right brace) is the definition of that aggregate. This definition might include methods and/or instance variables. To handle the nested definition, a new parser (the same as the operating one) is launched on that portion of the source code for that definition (i.e. from the ‘{’ to the ‘}’. The sub-parser is used so that the namespace of the items inside the braces can be preserved. The namespace is usually the name of the aggregate.

If a ‘template’ keyword is located, the keyword along with any arguments associated with the template are skipped, to ensure that any keywords inside the template arguments do not interfere with the handling of classes, structures or unions.

If a ‘typedef’ keyword is found, a flag is set to note that it has been discovered. Later, when tags for a structure or union are found, they become type aliases if the ‘typedef’ keyword was flagged. Otherwise, the tags are classed as variable names.

In step 112, reverse pattern matching for definitions is performed. Definitions include all possible declarations. They are referred to as definitions because they may have initializers and they are not aggregate or function declarations. Definitions normally form a complete line of code. Matching for definitions proceeds in three phases: first the line is completed if it's not already complete; then the complete list of tokens for a line (ending in a semicolon) are filtered to remove white space/comments and to ensure tokens are properly formed (for example tokens separated by a double colon token are condensed into one token to ensure identifiers are always properly qualified); finally, the completed and filtered tokens are matched for a definition pattern.

The reverse pattern matching for a single declaration is performed in two stages. In the first stage, filtering is performed. In stage 2, matching is performed. After an identifier is located, the tokens gathered during filtering are matched against known patterns.

Quasi-resolved parameter lists permit the fuzzy parser 10 to communicate a partial resolution of the types of parameters to the type resolver 40. The type resolver 40 uses these results as clues when resolving overloaded function or method calls.

Because the fuzzy parser 10 will not always see the declaration for an identifier in the same file that contains the identifier, the fuzzy parser 10 cannot always determine the type of a given identifier. This can cause problems when trying to cross-reference a function or method that is overloaded. In order to properly cross-reference an overloaded function or method call, it is necessary to select a version that matches the parameter types with the types that were used in calling the function or method. However, if one or more of the parameters being received is an identifier expression of an unknown type, or a function call with an unknown return type, then the type resolver 40 is required to make a best guess, or attempt to resolve the type of the parameter. To aid in this task, the fuzzy parser 10 attempts to fill in as much type information as possible for each function and method parameter. In some cases, the parameter type is known. In other cases, the parameter type might not be deterministic at all, or it may be that with some further investigation by the type resolver 40 can determine the parameter type. This mix of known, calculable and unknown types for the parameters associated with a function or method call is referred to as a “quasi-resolved parameter list”. Without such a list, the type resolver 40 is not able to select a correct instance of overloaded function or method. For every parameter in a function call, a quasi-resolved parameter is output. The quasi-resolved parameter list is a 1:1 ordered mapping to the original parameter list.

The following improve the scalability of the methods in accordance with the invention:

Separating parsing and type resolution;

Making both parsing and type resolution linear processes;

Parallel processing for parsing;

Parsing all source files only once;

Using a fast reverse pattern matching algorithm for parsing;

Hashing information to conserve space; and

Hierarchically arranging the cross-reference data so that it can be paged or narrowed in scope.

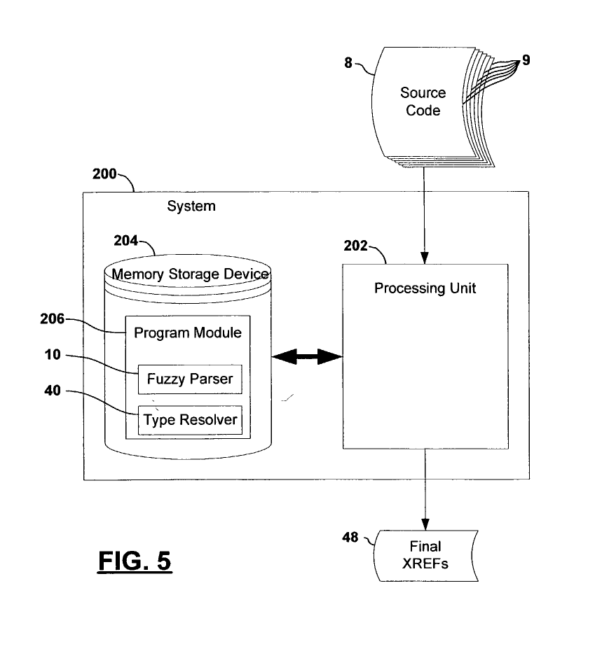

FIG. 5 is a schematic diagram of a fuzzy parser system 200 in accordance with an exemplary embodiment of the present invention. The fuzzy parser system 200 comprises a processing unit 202 and a memory storage device 204. A program module 206 is stored in the memory storage device 204. The program module 206 comprises computer code to implement the fuzzy parser 10, and the type resolver 40. The system 200 accepts source code 8 as input and produces a list of final cross-references (Final XREFs 48) as an output.

The embodiments of the invention described above are intended to be exemplary only. The scope of the invention is therefore intended to be limited solely by the scope of the appended claims.

I/We claim:

1. A method of parsing source code to extract cross-references and other source code browsing information, the method comprising steps of:
in a first pass, performing an approximate parse of the source code to extract the cross-references that are resolvable, as well as the browsing information;
in a second pass, applying heuristics to a list of cross-references that remained unresolved after the first pass, to generate more complete cross-references to the source code.

2. The method as claimed in claim 1, wherein performing the first pass further comprises a step of building a class hierarchy.

3. The method as claimed in claim 1, wherein the step of performing the approximate parse further comprises a step of using reverse pattern matching to process the source code.

4. The method as claimed in claim 1, wherein performing the first pass further comprises a step of using heuristics to process the source code.

5. The method as claimed in claim 4, wherein performing the first pass further comprises a step of using heuristics to process bodies of functions and methods within the source code.

6. The method as claimed in claim 1, wherein performing the second pass further comprises a step of resolving the unresolved cross-references by type.

7. The method as claimed in claim 1, further comprising a step of subdividing multiple source code files into subsets or source code files, and simultaneously performing the approximate parse of each subset using a separate processor to perform each approximate parse.

8. A system for parsing source code to extract cross-references and other source code browsing information, comprising:
a processing unit;
a memory;
a program module stored in the memory, the program module being executable by the processing unit to perform in a first linear pass, an approximate parse of the source code to resolve cross-references that are resolvable in the first linear pass, as well as to extract other information useful for browsing the source code; and, in a second linear pass, to apply heuristics to a list of unresolved cross-references produced during the first linear pass to generate a more complete model of cross-references and the other information useful for browsing the source code.

9. A system as claimed in claim 8 wherein in the first pass, the system is adapted to process the source code in chunks delimited by a right brace or a semicolon token.

10. A system as claimed in claim 9 wherein the system is further adapted to search each chunk for a macro token and, if a macro token is located, to cross-reference the macro token without delay.

11. A system as claimed in claim 9 wherein the system is further adapted to perform reverse pattern matching to locate any function declarations in the chunk.

12. A system as claimed in claim 11 wherein the system is further adapted to perform reverse pattern matching of the chunk to locate any aggregate types in the chunk.

13. A system as claimed in claim 12 wherein if a keyword “enum” is found, all tokens are skipped until a next right brace token is located, and checks are made to ensure that the right brace token is proceeded by an identifier tag.

14. A system as claimed in claim 13 wherein if a keyword “class”, “struct” or “union” keyword is located a flag is set to note which keyword was found, a type name is generated for the aggregate, and an inner loop is launched to search for a right brace token, an equal sign token, a colon token or an identifier token.

15. A system as claimed in claim 12 wherein the system is further adapted to perform reverse pattern matching to locate any definitions in the chunk.

16. A computer readable medium storing computer executable instructions for parsing source code to extract cross-references and other source code browsing information, comprising:
instructions for performing an approximate parse of the source code in a first pass to resolve resolvable cross-references and extract browsing information; and
instructions for applying heuristics to a list of unresolved cross-references in a second pass, to generate a more complete model of the cross-references and other browsing information for the source code.

17. A computer readable medium as claimed in claim 16, wherein the first pass further comprises instructions for building a class hierarchy.

18. A computer readable medium as claimed in claim 16, further including instructions for performing the approximate parse using reverse pattern matching to process the source code.

19. A computer readable medium as claimed in claim 16, further including instructions for using heuristics the first pass to process the source code.

20. A computer readable medium as claimed in claim 16, further including instructions for using heuristics in the first pass to process bodies of functions and methods within the source code.

21. A computer readable medium as claimed in claim 16, further including instructions for resolving the unresolved cross-references in the second pass by type.
